(19) United States
(12) Patent Application Publication
(10) Pub. No.: US 2026/0332944 A1
(43) Pub. Date: Oct. 22, 2026

(54) SPEAKER

(71) Applicant: Merry Electronics (Shenzhen) Co., Ltd., ShenZhen (CN)

(72) Inventor: HUNG JEN CHO, ShenZhen (CN)

(21) Appl. No.: 19/260,640

(22) Filed: Jul. 7, 2025

(30) Foreign Application Priority Data
Apr. 16, 2025 (TW) 114114290

(51) Int. Cl. H04R 1/28; H04R 1/02

(52) U.S. Cl. CPC H04R 1/2896; H04R 1/025; H04R 1/2811; H04R 1/288

(57) ABSTRACT

A speaker has a basket, a supporting element, a speaker driver, and a passive surround. The supporting element is disposed in the basket. The passive surround is directly connected to the driver surround of the speaker driver and the basket such that the passive surround and the supporting element jointly suspend the driver in the basket. The outstanding compliant dynamic strikes of the speaker driver and the passive surround passively vibrating with the speaker driver reduce low-frequency distortion, improve bass sound effects, and save space inside a speaker box. Also, the speaker can provide great sound quality in low-frequency fields via less compensation, which reduces electricity usage and saves energy.

### BACKGROUND OF THE INVENTION

### 1. Field of the Invention

The present invention relates to a speaker, and particularly to a speaker capable of enhancing low-frequency performance without a vibration plate of a passive radiator.

### 2. Description of Related Art

A conventional speaker has a box, a speaker driver, and a passive radiator. The speaker driver and the passive radiator are mounted to the box separately. E.g., the speaker driver and the passive radiator are respectively located on a front side and a rear side of the box, or both located on the front side of the box at a spaced interval.

However, the passive radiator in the conventional speaker has the following issues:
1. Only supported by a single surround, the passive radiator is more likely to suffer excessive vibration which leads to low-frequency distortion.
2. The spaced interval between the passive radiator and the speaker driver may be too large and causes delay in low-frequency fields and incapability in presenting clear low-frequency timbre.
3. The passive radiator is an individual modularized structure with a diaphragm. Hence, the conventional passive radiator is wider in size, space-consuming, and disadvantageous to miniaturization design for speakers.

### SUMMARY OF THE INVENTION

The main objective of the present invention is to provide a speaker which has a passive surround and a supporting element jointly suspending a speaker driver to mitigate and obviate the issues of the conventional speaker.

The speaker has a basket, a supporting element, a speaker driver, and a passive surround. The supporting element is disposed in the basket. The speaker driver is located in the basket, connected to the supporting element, and has a driver surround. The passive surround is annular and has an inner side and an outer side. The inner side of the passive surround is directly connected to the driver surround of the speaker driver, and the outer side of the passive surround is directly connected to the basket such that the passive surround and the supporting element jointly suspend the driver in the basket.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of a speaker in accordance with the present invention;

FIG. 2 is a perspective view of the speaker in FIG. 1 in partial section;

FIG. 3 is a perspective view of the speaker in FIG. 1 in partial section from another view angle;

FIG. 4 is an exploded view of the speaker in FIG. 1;

FIG. 5 is an exploded view of the speaker in FIG. 1 from another view angle;

FIG. 6 is a side view of the speaker in FIG. 1 in partial section;

FIG. 7 is a frequency response graph comparing speakers of the preferred embodiment in FIG. 1 and a comparative embodiment; and

FIG. 8 is a total harmonic distortion graph comparing the speakers of the preferred embodiment in FIG. 1 and the comparative embodiment.

### DETAILED DESCRIPTION OF THE PREFERRED EMBODIMENT

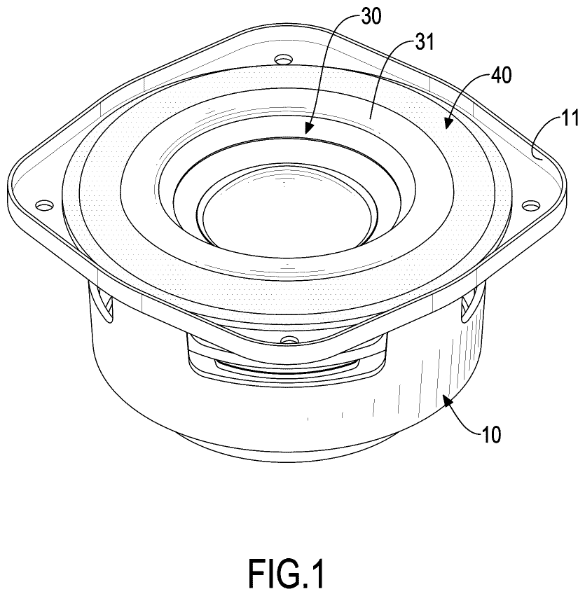

With reference to FIGS. 1 to 4, a preferred embodiment of a speaker in accordance with the present invention has a basket 10, a supporting element 20, a speaker driver 30, and a passive surround 40. The basket 10 is configured for connecting other components of the speaker and for combining a speaker box. Methods for above-mentioned connection and combination are basically the same as conventional methods.

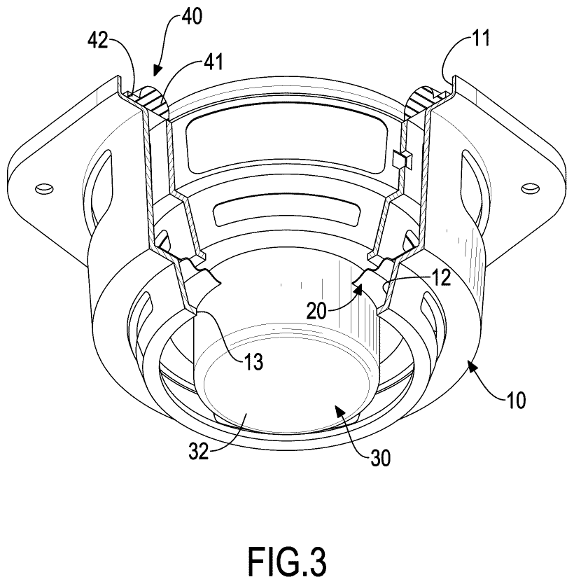

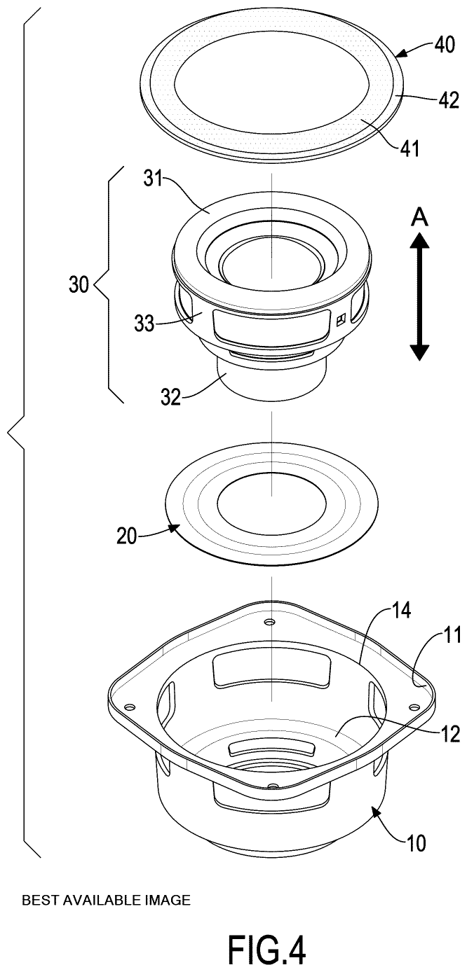

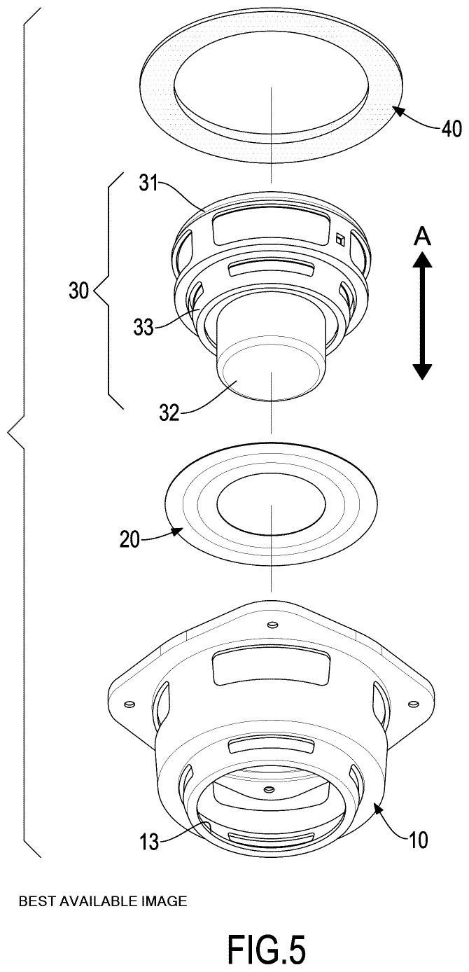

The supporting element 20 is disposed in the basket 10. In the preferred embodiment, with reference to FIGS. 4 to 6, the basket 10 has a basket body being basically annular. The supporting element 20 is located near a bottom inside the basket 10. With reference to FIGS. 3 to 6, the speaker driver 30 is located in the basket 10, is connected to the supporting element 20, and has a driver surround 31. The driver surround 31 is annularly formed on a periphery of the speaker driver 30. Further, the speaker driver 30 is electrically connected to a controller and is configured to convert electric signals from the controller to sound waves.

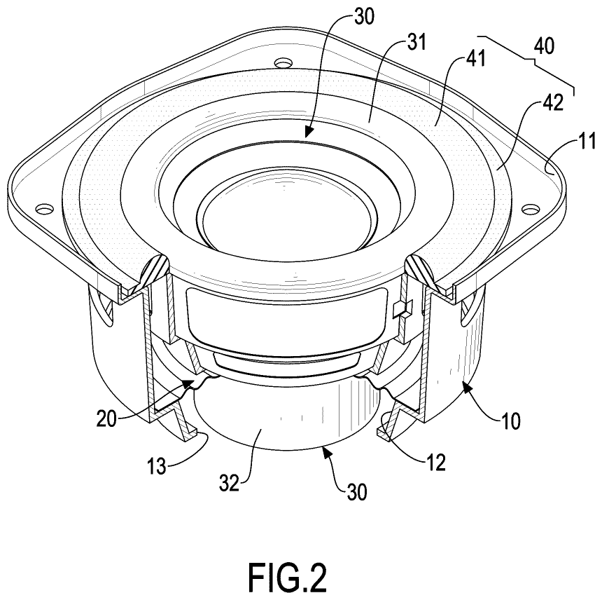

With reference to FIGS. 2, 4, and 6, the passive surround 40 is annular and has an inner side and an outer side. The inner side of the passive surround 40 is directly connected to the driver surround 31 of the speaker driver 30, and the outer side of the passive surround 40 is directly connected to the basket 10. Hence, the passive surround 40 and the supporting element 20 jointly suspend the speaker driver 30 in the basket 10. In other words, no part of the speaker driver 30 is adjacent to the basket 10. Instead, the speaker driver 30 is located in the basket 10 and indirectly connected to the basket 10 through the supporting element 20 and the passive surround 40.

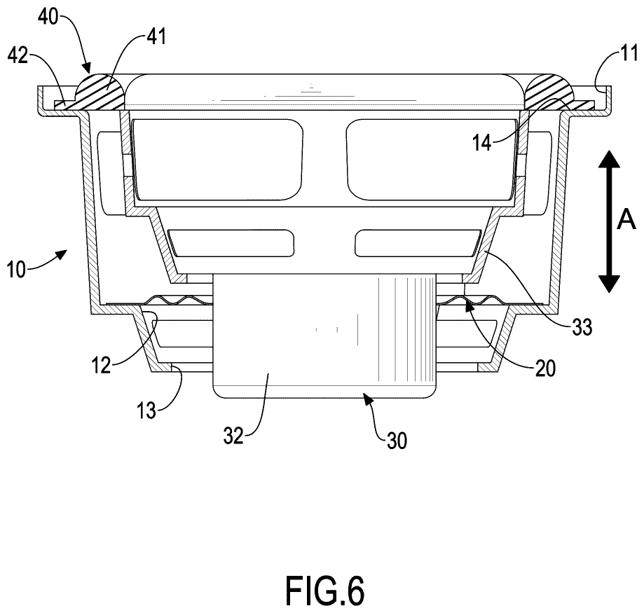

Since the speaker driver 30 is suspended in the basket 10, when converting electric signals to sound waves, the speaker driver 30 vibrates in an axial direction A as shown in FIG. 6 in the basket 10 and drives the passive surround 40 and the supporting element 20, which are located between the speaker driver 30 and the basket 10, to vibrate correspondingly. With the above technical features, the speaker in accordance with the present invention has the following efficacy:
1. The passive surround 40 is connected between the driver surround 30 and the basket 10. Thereby, the passively vibrating passive surround 40 reconciles with the speaker driver 30 (vibration source), which provides a limitation effect on vibrations and prevents low-frequency distortion due to excessive vibration. Also, the outstanding compliant dynamic strokes of the speaker driver 30 can effectively reduce distortion. Compared with the conventional speaker whose speaker driver is not connected with a passive surround, the passive surround 40 in the present invention enhances resonance of the speaker driver 30 in low-frequency fields to improve bass sound effect.
2. The passive surround 40 is connected between the driver surround 30 and the basket 10, so delay in low-frequency fields can be minimized. The speaker of the present invention thus presents clear low-frequency timbre.
3. The passive surround 40 is directly connected between the speaker driver 30 and the basket 10 and provides bass sound effect as the conventional passive radiator with no need of a diaphragm and/or a vibration plate of the conventional passive radiator. Thus, the speaker of the present invention takes less space, saves space inside the speaker box, and is beneficial for miniaturization design for speakers. E.g., the speaker can be applied as a portable speaker and provides clear and improved bass sound effect.
4. By saving space inside the speaker box, the speaker of the present invention effectively reduces distortion, has great response in low-frequency fields and great extensibility of bandwidth, and provides great sound quality in low-frequency fields via less compensation. Hence, the speaker of the present invention reduces electricity usage and saves energy.

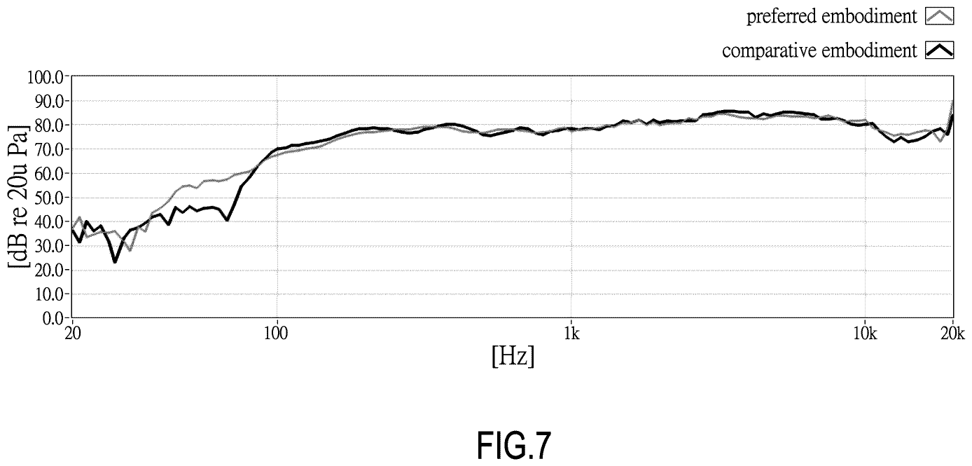

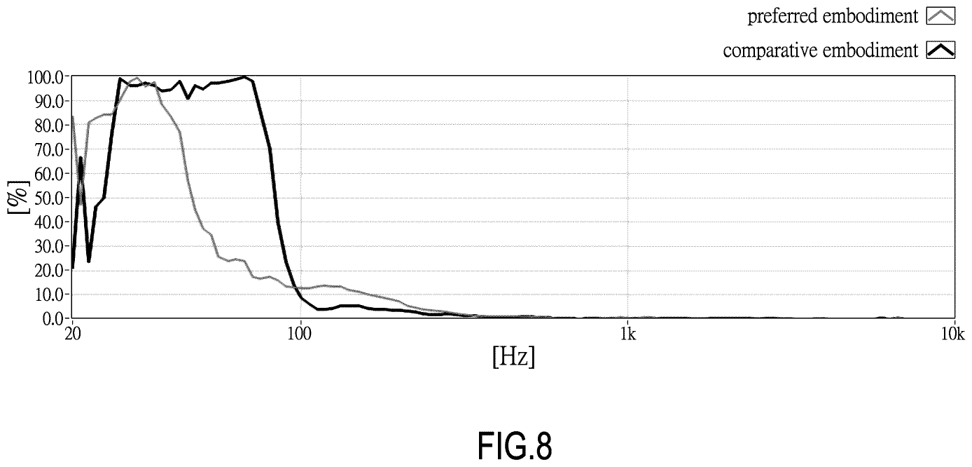

The speaker further combines a rectangular speaker box being 4 centimeters long, 6 centimeters wide, and 6 centimeters high, and the speaker driver 30 is disposed on a front side of the speaker box. With reference to FIGS. 7 and 8, two speakers are put to tests: the preferred embodiment of the speaker with the above-mentioned speaker box and a speaker of a comparative embodiment having a speaker driver on the front side of the speaker box and a passive radiator on a rear side of the speaker box, i.e., the conventional speaker in the description of related art. In the comparative embodiment, sizes of surrounds of the speaker driver and the passive radiator respectively equal sizes of the driver surround 31 and the passive surround 40 in the preferred embodiment for being control variables in the tests.

With reference to FIG. 7, in the frequency response (FR) graph of the speakers from the preferred embodiment of the present invention and the comparative embodiment, when the frequency is slightly lower than 100 hertz, the preferred embodiment of the present invention has better frequency response than the comparative embodiment, and the largest difference between sound responses of the preferred embodiment of the present invention and the comparative embodiment is near 20 decibels (near 60 decibels compared to approximate 40 decibels).

With further reference to FIG. 8, in the total harmonic distortion (THD) graph of the preferred embodiment of the present invention and the comparative embodiment, in the same frequency range, distortion rate of the preferred embodiment of the present invention is much lower than that of the comparative embodiment, and the largest difference between distortion rates of the preferred embodiment of the present invention and comparative embodiment is over 80% (lower than 20% compared to nearly 100%). Thence, compared to the conventional speaker, the preferred embodiment of the speaker of the present invention provides clearer sound quality in low-frequency fields and has a better performance on distortion rate.

Further, with reference to FIGS. 3 to 6, the basket 10 has an opening 11, a bottom groove 12, and a through hole 13. The opening 11 and the bottom groove 12 are respectively located on interiors of a top side and a bottom side being opposite to each other in an axial direction A of the basket 10. The through hole 13 is formed through the bottom groove 12. The supporting element 20 is disposed on the bottom groove 12 and is adjacent to the through hole 13. In the preferred embodiment, the basket 10 has a top-to-bottom tapering structure. Thus, a portion of the speaker driver 30 which is connected to and supported by the supporting element 20 is near a bottom of the basket 10. Specifically, the supporting element 20 is a flexible and annular structure; e.g., a damper/a spider.

Preferably, in the preferred embodiment, the speaker driver 30 has a driving component 32 having an outer diameter smaller than an inner diameter of the supporting element 20 and an inner diameter of the through hole 13, such that the driving component 32 extends through the supporting element 20 and the through hole 13 from an interior of the basket 10. In other words, the driving component 32 of the speaker driver 30 protrudes from the bottom side of the basket 10 and has a width smaller than that of the basket 10. Thereby, the basket 10 may have a smaller volume as long as the combined speaker box has a sufficient depth for the speaker driver 30 to vibrate along the axial direction A. The speaker is thus suitable for miniaturization design.

The speaker driver 30 may have a diaphragm, a voice coil, a magnet, a dust cap, and other structures of the conventional speaker driver inside the driver surround 31; e.g., the driving component 32 may be composed of a magnet and a voice coil. Speaking structures and work principles of the speaker driver 30 are basically the same as the conventional speaker driver. As long as a speaker driver has the technical features described in the preferred embodiment, the speaker driver falls into the scope of the present invention.

In the preferred embodiment, with reference to FIGS. 4 to 6, the speaker driver 30 further has an inner basket 33 for connecting the diaphragm, the voice coil, the magnet, the dust cap, and other structures described above. With reference to FIG. 6, the inner basket 33 is spaced from the basket 10, the supporting element 20, and the passive surround 40 without contact therewith.

With reference to FIGS. 2 to 4 and 6, the basket 10 further forms a flange 14 around the opening 11 for the passive surround 40 to be connected thereto. The passive surround 40 is directly connected between the driver surround 31 of the speaker driver 30 and the flange 14 of the basket 10. Thus, the widest part of the speaker, i.e., the flange 14 around the opening 11 of the basket 10, may have a minimized size. That is, the flange 14, the passive surround 40, and the driver surround 31 of the speaker driver 30 are tightly connected to each other in an inward sequence for convenience of miniaturization design for the speaker.

Preferably, with reference to FIGS. 2 to 4 and 6, the passive surround 40 has a body 41 and a protruding edge 42. The protruding edge 42 is formed on a periphery of the body 41 and attached to the flange 14 to connect the passive surround 40 and the basket 10. The driver surround 31 and the body 41 of the passive surround 40 protrude from a surface of the protruding edge 42 along the axial direction A; i.e., the driver surround 31 and the body 41 of the passive surround 40 protrude upward. In addition, in the preferred embodiment, each one of the driver surround 31 and the body 41 of the passive surround 40 has a uniform and fixed thickness; i.e., without any jagged and uneven structure.

Preferably, in the preferred embodiment, the passive surround 40 is an individual component and is connected to the driver surround 31, so as to mitigate the problems of the conventional speaker. In other embodiments, the driver surround 31 and the passive surround 40 may be formed in one piece. That is, the driver surround 31 and the passive surround 40 can be manufactured at the same time, which reduces time and cost of manufacturing the speaker. Also, the above-mentioned one-piece configuration may reduce discrete manufacturing and prevent the driver surround 31 and the passive surround 40 from terrible connection or even reconnection.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A speaker comprising:
a basket;
a supporting element disposed in the basket;
a speaker driver located in the basket, connected to the supporting element, and having a driver surround; and
a passive surround being annular and having
an inner side directly connected to the driver surround of the speaker driver; and
an outer side directly connected to the basket such that the supporting element and the passive surround jointly suspend the speaker driver in the basket.

2. The speaker as claimed in claim 1, wherein
the basket has
an opening and a bottom groove respectively located on two opposite sides of the basket; and
a through hole formed through the bottom groove; and
the supporting element is disposed on the bottom groove and is adjacent to the through hole.

3. The speaker as claimed in claim 2, wherein the basket has a flange formed around the opening, and the passive surround is connected to the flange.

4. The speaker as claimed in claim 3, wherein
the speaker has an axial direction;
the passive surround has a body and a protruding edge formed on a periphery of the body and attached to the flange; and
the driver surround and the body of the passive surround protrude from a surface of the protruding edge along the axial direction.

5. The speaker as claimed in claim 2, wherein the supporting element is a flexible annular structure.

6. The speaker as claimed in claim 5, wherein the speaker driver has a driving component having an outer diameter smaller than both an inner diameter of the supporting element and an inner diameter of the through hole such that the driving component extends through the supporting element and the through hole from an interior of the basket.

7. The speaker as claimed in claim 5, wherein the supporting element is a damper.

8. The speaker as claimed in claim 1, wherein the driver surround and the passive surround are formed in one piece.

9. The speaker as claimed in claim 1, wherein the speaker is a portable speaker.

10. The speaker as claimed in claim 2, wherein the speaker is a portable speaker.

11. The speaker as claimed in claim 3, wherein the speaker is a portable speaker.

12. The speaker as claimed in claim 4, wherein the speaker is a portable speaker.

13. The speaker as claimed in claim 5, wherein the speaker is a portable speaker.

14. The speaker as claimed in claim 6, wherein the speaker is a portable speaker.

15. The speaker as claimed in claim 7, wherein the speaker is a portable speaker.

16. The speaker as claimed in claim 8, wherein the speaker is a portable speaker.
